(19) United States
(12) Patent Application Publication
(10) Pub. No.: US 2023/0204422 A1
(43) Pub. Date: Jun. 29, 2023

(54) IMAGING ASSEMBLY AND SPECTRAL IMAGING ELLIPSOMETER INCLUDING THE SAME

(71) Applicant: Samsung Electronics Co., Ltd., Suwon-si (KR)

(72) Inventors: Jinwoo Ahn, Yongin-si (KR); Juntaek Oh, Hwaseong-si (KR); Youngkyu Park, Incheon (KR); Eunsoo Hwang, Seoul (KR)

(21) Appl. No.: 17/955,881

(22) Filed: Sep. 29, 2022

(30) Foreign Application Priority Data
Dec. 28, 2021 (KR) 10-2021-0189237

(51) Int. Cl. G01J 3/447; G01N 21/95; G01N 21/21; G01J 3/02

(52) U.S. Cl. CPC G01J 3/447; G01N 21/9501; G01N 21/211; G01J 3/021; G01J 3/0208; G01N 2021/213

(57) ABSTRACT

An imaging assembly of a spectral imaging ellipsometer includes an analyzer configured to polarize reflected light reflected from a sample surface, an imaging mirror optical system disposed on an optical path of the reflected light passing through the analyzer and including a first mirror having a concave surface and a second mirror having a convex surface, and a light detector configured to receive light passing through the imaging mirror optical system to collect spectral data. The reflected light is firstly reflected by the first mirror, the firstly reflected light is secondarily reflected by the second mirror and travels toward the first mirror again, and then thirdly reflected by the first mirror to be imaged on a light receiving surface of the light detector.

### PRIORITY STATEMENT

This application claims priority under 35 U.S.C. § 119 to Korean Patent Application No. 10-2021-0189237, filed on Dec. 28, 2021 in the Korean Intellectual Property Office (KIPO), the contents of which are herein incorporated by reference in their entirety.

### BACKGROUND

### 1. Field

Example embodiments relate to an imaging assembly and a spectral imaging ellipsometer including the same. More particularly, example embodiments relate to an imaging assembly for imaging reflected light from a wafer surface and a spectral imaging ellipsometer including the same.

### 2. Description of the Related Art

Spectral elliptic polarization analysis technology is a technology that irradiates polarized light to a sample and measures a change in a polarization state of the reflected light. The change in polarization (spectrum) according to the wavelength depends on physical properties and a structure of the sample. The physical properties and structure information of the sample may be extracted and measured using the spectrum obtained through the spectral imaging ellipsometer. The spectral imaging ellipsometer may include an imaging lens optical system including lenses to image the light reflected from the sample. However, there are problems in that a large number of lenses are used in order to satisfy optical performance in a broadband wavelength, so that the transmittance is lowered, the measurement speed is lowered, and chromatic aberration occurs, which causes a focus deviation for each wavelength.

### SUMMARY

Example embodiments provide an imaging assembly of a broadband high-efficiency spectral imaging ellipsometer that provides improved transmittance and avoids chromatic aberration.

Example embodiments provide a spectral imaging ellipsometer including the imaging assembly.

According to example embodiments, an imaging assembly of a spectral imaging ellipsometer includes an analyzer configured to polarize reflected light reflected from a sample surface, an imaging mirror optical system disposed on an optical path of the reflected light passing through the analyzer and including a first mirror having a concave surface and a second mirror having a convex surface, and a light detector configured to receive light passing through the imaging mirror optical system to collect spectral data. The reflected light is firstly reflected by the first mirror, the firstly reflected light is secondarily reflected by the second mirror and travels toward the first mirror again, and then thirdly reflected by the first mirror to be imaged on a light receiving surface of the light detector.

According to example embodiments, a spectral imaging ellipsometer includes a light irradiator configured to irradiate a polarized light whose direction changes on a sample surface to generate reflected light, an analyzer configured to polarize the reflected light reflected from the sample surface, an imaging mirror optical system disposed on an optical path of the reflected light passing through the analyzer and including a first mirror having a concave surface and a second mirror having a convex surface, a light detector configured to receive light passing through the imaging mirror optical system to collect spectral data, and a controller configured to control operations of the light irradiator and the analyzer. The centers of the radii of curvature of the first mirror and the second mirror are arranged to coincide with one point, and at least three reflections of the reflected light are provided in the first and second mirrors.

According to example embodiments, a spectral imaging elliptic spectrometer may include a light irradiator configured to irradiate light having a polarization component to multiple points on a wafer surface and an imaging assembly configured to receive the reflected light reflected from the wafer to obtain an image according to the polarization state at each of the plurality of points.

The light irradiator may include a monochromator for separating a narrow wavelength band (i.e., a specific spectrum range) from a broadband wavelength, and the image assembly may include an analyzer for polarizing the reflected light, an imaging mirror optical system disposed on an optical path of the reflected light passing through the analyzer and a two-dimensional image sensor as a light detector for receiving the light passing through the mirror optical system to collect the spectral data.

The imaging mirror optical system may be a mirror-based imaging optical system composed of at least two mirrors. When the mirror-based imaging optical system is used, transmittance of the optical system may be increased to improve measurement sensitivity in a narrow wavelength band (i.e., a specific spectrum range) and measurement speed in a broad wavelength band, and the occurrence of chromatic aberration may be reduce to thereby minimize focus deviation for each wavelength.

### BRIEF DESCRIPTION OF THE DRAWINGS

Example embodiments will be more clearly understood from the following detailed description taken in conjunction with the accompanying drawings. FIGS. 1 to 10 represent non-limiting, example embodiments as described herein.

FIG. 1 is a block diagram illustrating a spectral imaging ellipsometer in accordance with example embodiments.

FIG. 2 is a view illustrating spectral images for wavelengths detected by a detector of the spectral imaging ellipsometer in FIG. 1.

FIG. 3 is a view illustrating a spectral matrix generated by a processor of the spectral imaging ellipsometer in FIG. 1.

FIG. 4 is a view illustrating a light intensity spectrum for wavelengths in one pixel in FIG. 2.

FIG. 5 is a block diagram illustrating an imaging assembly of a spectral imaging ellipsometer in accordance with example embodiments.

FIG. 6 is a view illustrating an imaging mirror optical system of the imaging assembly in FIG. 5.

FIG. 7 is a block diagram illustrating an imaging assembly of a spectral imaging ellipsometer in accordance with example embodiments.

FIG. 8 is a block diagram illustrating an imaging assembly of a spectral imaging ellipsometer in accordance with example embodiments.

FIG. 9 is a block diagram illustrating an imaging assembly of a spectral imaging ellipsometer in accordance with example embodiments.

FIG. 10 is a block diagram illustrating an imaging assembly of a spectral imaging ellipsometer in accordance with example embodiments.

### DETAILED DESCRIPTION OF EXAMPLE EMBODIMENTS

Hereinafter, example embodiments will be explained in detail with reference to the accompanying drawings.

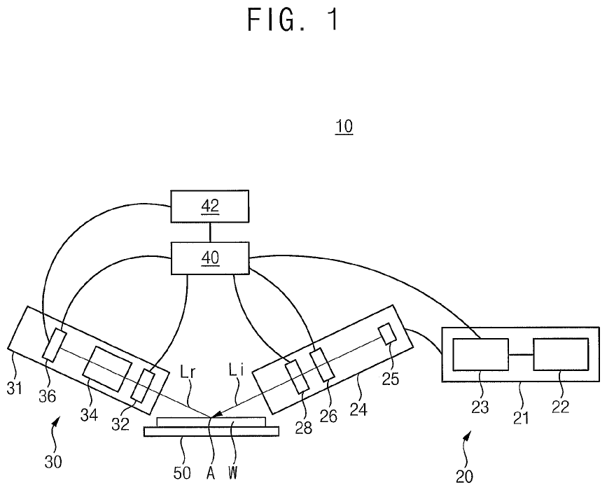

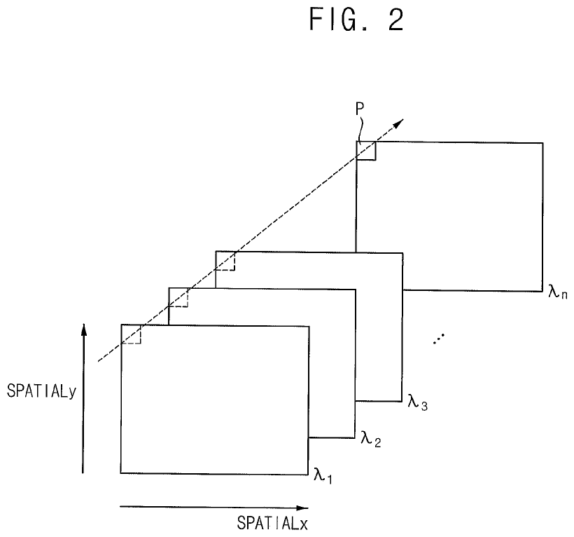

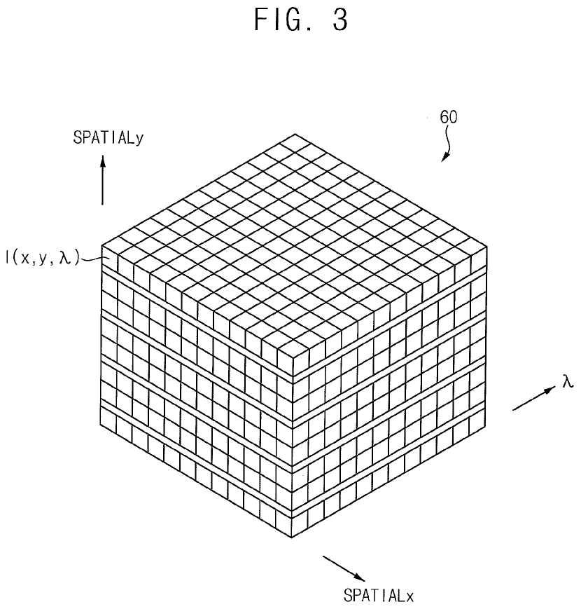

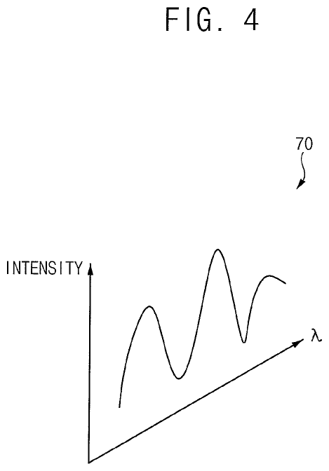

FIG. 1 is a block diagram illustrating a spectral imaging ellipsometer in accordance with example embodiments. FIG. 2 is a view illustrating spectral images for wavelengths detected by a detector of the spectral imaging ellipsometer in FIG. 1. FIG. 3 is a view illustrating a spectral matrix generated by a processor of the spectral imaging ellipsometer in FIG. 1. FIG. 4 is a view illustrating a light intensity spectrum for wavelengths in one pixel in FIG. 2.

Referring to FIGS. 1 to 4, a spectral imaging ellipsometer 10 may include a light irradiator 20 configured to irradiate a polarized light Li whose direction changes on a sample surface A such as a wafer W and a detector 30 configured to receive a light Lr reflected from the wafer W and detect an image according to a polarization state at each of a plurality of points on the sample surface A. In addition, the spectral imaging ellipsometer 10 may further include a controller 40 configured to control operations of the light irradiator 20 and the detector 30, a processor 42 configured to process data of the detected image, and a stage 50 configured to support the wafer W. The controller 40 may be a hardware device or a software program that is configured to control operations of the illumination assembly 24 and the light detector 36. For example, the controller 40 may be configured to manage or direct the flow of data among the processor 42 and the components of the illumination assembly 24 and the light detector 36. In addition, the controller 40 may be configured to send commands (e.g., position adjustment commands) and receive data (e.g., positioning data) to and from components of the illumination assembly 24 and the light detector 36.

In example embodiments, the spectral imaging ellipsometer 10 may be an imaging elliptic spectroscopy apparatus (e.g., spectroscopic elliptic spectrometer) of a surface measurement type that measures multiple points instead of one point on the wafer surface. In addition, the spectral imaging elliptic spectrometer 10 may irradiate the wafer surface with light having a broadband wavelength in order to obtain desired information on a miniaturized semiconductor structure, thickness, physical properties, etc. For this imaging elliptic spectroscopy apparatus, the light irradiator 20 may include a monochromator 23 configured to select and transmit a narrow wavelength band from a wide wavelength band, and a light detector 36 may include a camera as a two-dimensional image sensor.

The wafer W may be a semiconductor substrate. For example, the semiconductor substrate may include or may be formed of silicon, strained silicon (strained Si), silicon alloy, silicon carbide (SiC), silicon germanium (SiGe), silicon germanium carbide (SiGeC), germanium, germanium alloy, gallium arsenide (GaAs), indium arsenide (InAs) and III-V semiconductors, II-VI semiconductors and a combination thereof. In addition, if necessary, the wafer may be an organic plastic substrate rather than the semiconductor substrate.

The wafer W may be supported on the stage 50. The stage 50 may move the wafer W to a specific position during a measurement process. For example, the stage 50 may move the wafer W in a first direction or a second direction perpendicular to the first direction.

As illustrated in FIG. 1, the light irradiator 20 may irradiate the polarized light Li whose direction changes toward the surface of the wafer W. The light irradiator 20 may inject the polarized light Li at a predetermined angle with respect to the surface of the wafer W. The light irradiator 20 for measurement may include a light source assembly 21 and an illumination assembly 24. The light source assembly 21 may include a light source 22 and the monochromator 23. The illumination assembly 24 may include an illumination optical system 25, a polarizer 26 as a first polarizer, and a compensator 28 as a second polarizer.

The light source 22 may generate broadband light. For example, the light source 22 may emit visible light. The wavelength band of the light generated by the light source 22 may vary depending on the object to be measured, and may generally have a bandwidth ranging from Ultraviolet (UV) band to Near Infrared (NIR) band. The monochromator 23 may extract light of a specific wavelength from the light generated from the light source 22. For example, the monochromator 23 may extract monochromatic light from broadband light and illuminate the monochromatic light through the illumination assembly 24.

The light emitted from the light source assembly 21 may travel along a path of the incident light Li in the illumination assembly 24. Light emitted from the light source assembly 21 into the illumination assembly 24 may be converted into parallel light by a collimator lens of the illumination optical system 25. An illumination body of the illumination assembly 24 may extend in the same direction as the path of the incident light Li, and the polarizer 26 and the compensator 28 may be fixedly installed in the illumination body. The incident light Li may be irradiated to a measurement area A of the wafer W placed on the stage 50 through the polarizer 26 and the compensator 28.

The polarizer 26 may adjust a polarization direction of the incident light Li. The polarizer 26 may include a rotating part that can adjust the polarization direction, and may rotate at a first angle. The first angle of the polarizer 26 may be maintained to have a constant value. Alternatively, the polarizer 26 may be electrically connected to the controller 40, and the controller 40 may adjust the first angle of the polarizer 26.

The compensator 28 may adjust a phase difference of the incident light Li. The compensator 28 may include a rotating part, and may rotate at a second angle. The compensator 28 may adjust the phase difference of the incident light Li by using the rotating part. The compensator 28 may be electrically connected to the controller 40. The controller 40 may adjust the second angle of the compensator 28. Accordingly, the incident light Li as monochromatic light extracted from the light generated from the light source 22 may be irradiated to the measurement area A on the wafer W, and the reflected light Lr reflected from the wafer W may be collected into an imaging assembly 31 of the detector 30.

The detector 30 may receive the light Lr reflected from the wafer W to detect a two-dimensional image of the sample surface A according to a polarization change. The detector 30 may include an analyzer 32 as a third polarizer provided in the imaging assembly 31, an imaging mirror optical system 34 and the light detector 36. The analyzer 32, the imaging mirror optical system 34 and the light detector 36 may be fixedly installed in an emitting body of the imaging assembly 31.

The analyzer 32 may adjust a polarization direction of the reflected light Lr reflected from the wafer W. The analyzer 32 may include a rotating part, and may rotate at a third angle. The analyzer 32 may be electrically connected to the controller 40. The controller 40 may adjust the third angle of the analyzer 32. The analyzer 32 may transmit only a linearly polarized light component corresponding to the third angle.

The imaging mirror optical system 34 may image the reflected light Lr passing through the analyzer 32 on a light receiving surface of the light detector 36. The imaging mirror optical system 34 may have an object plane and an imaging plane as conjugate planes. The object plane of the imaging mirror optical system 34 may be positioned on the wafer surface, and the imaging plane of the imaging mirror optical system 34 may be positioned on the light receiving plane of the light detector 36.

The imaging mirror optical system 34 may have a relatively long working distance WD. The analyzer 32 may be positioned between the object plane and the imaging mirror optical system 34. The rotating part of the analyzer 32 may include a hollow type motor for adjusting the third angle. In this case, in consideration of a size of the hollow type motor, the imaging mirror optical system 34 may be designed to have a relatively long working distance.

In example embodiments, the imaging mirror optical system 34 may be a mirror-based imaging optical system including at least two mirrors. In the case of an existing lens-based optical system, since a large number (eg, 8 to 16) of lenses are used to satisfy optical performance of a broadband wavelength, transmittance may be reduced and chromatic aberration may occur. However, when the mirror-based imaging optical system is used, it may be possible to minimize chromatic aberration and secure transmittance in a specific wavelength region.

The light detector 36 may detect a spectral image from the reflected light Lr passing through the imaging mirror optical system 34. For example, the light detector 36 may detect a spectral image for a particular wavelength. The light detector 36 may include a camera as a two-dimensional image sensor capable of detecting the reflected light Lr.

The controller 40 may be connected to the monochromator 23, the polarizer 26, the compensator 28, the analyzer 32, the photo detector 36 and the processor 42 to control operations thereof. The controller 40 may receive a Polarizer, Compensator and Analyzer (PCA) angle set from the processor 42. The PCA angle set may include a first angle that corresponds to the rotation angle of the polarizer 26, a second angle that corresponds to the rotation angle of the compensator 28, and a third angle that corresponds to the rotation angle of the analyzer 32. The controller 40 may change the first to third angles by controlling the polarizer 26, the compensator 28 and the analyzer 32 according to the received PCA angle set.

The controller 40 may also generate a PCA angle set by changing the first to third angles according to a preset value. For example, while the first and second angles of the polarizer 26 and the compensator 28 are maintained at constant values, the third angle of analyzer 32 may be changed to generate a plurality of PCA angle sets.

The processor 42 may receive spectral images (see FIG. 2) from the light detector 36. The processor 42 may generate a PCAR (Polarizer, Compensator and Analyzer Rotating) spectral matrix 60 (see FIG. 3) by using the received spectral images. For example, the processor 42 may receive a first spectral image corresponding to a first set of PCA angles and a first wavelength and a second spectral image corresponding to a second set of PCA angles and a second wavelength different from the first wavelength from the light detector 36, and may generate the PCAR spectral matrix 60 using the first and second spectral images.

In addition, the processor 42 may generate a spectrum 70 (see FIG. 4) representing a change in intensity for wavelengths in each pixel of the spectral images by using the PCAR spectral matrix 60. The processor 42 may analyze the spectrum 70 to select a set of PCA angles and a wavelength band of optimal conditions for measurement parameters.

The processor 42 may be a central processing unit (CPU), a microprocessor, an application processor (AP), or any processing device similar thereto. The processor 42 may execute software or instructions that perform functionality of data analysis or optical critical dimension (OCD) operations including a spectrum recognition algorithm. The optical critical dimension operations may extract physical parameters of the inspection area of the wafer W from spectral data. The spectrum recognition algorithm of the optical critical dimension operations may use a Rigorous coupled-wave analysis (RCWA) algorithm. The rigorous coupled-wave analysis algorithm may be usefully used to explain diffraction or reflection of electromagnetic waves from a surface of a grating structure. However, it may not be limited thereto, and the processor 42 may apply a spectral image ellipse analysis technique, a multi-point high-speed measurement spectral ellipse analysis technique, etc. to monitor a profile change trend in the wafer W. In addition, the processor 42 may perform a variable separation algorithm such as a correlation analysis algorithm for extracting a profile change value from a plurality of spectra, a principal component analysis algorithm, a rank test, etc.

Measurement variables that can be measured by the spectral imaging ellipsometer 10 may include a critical dimension, a height of a pattern, a recess, an overlay, a defect, etc.

In the spectral imaging ellipsometer 10, when light having a polarization component is irradiated on the sample W to be inspected, reflectivity and phase values are changed according to the polarization directions (p-wave, s-wave). The spectral imaging ellipsometer 10 may measure electromagnetic field values of p-wave and s-wave while changing a combination of the PCA angle sets. The first angle of the polarizer 26 may determine the polarization direction of the light incident on the sample, and the second angle of the compensator 28 may determine the phase difference between the p-wave and the s-wave. The third angle of the analyzer 32 may determine the polarization direction of the light incident on the light detector 36 after being reflected from the sample.

The set of PCA angles may be selected depending on the measurement parameters. For example, it may be possible to select a different set of PCA angles for each wavelength λ. The PCA angle set may be selected randomly, in a predetermined order, or using a PCA angle set selection algorithm.

As illustrated in FIG. 2, respective spectral images may be obtained for each set of PCA angles by the light detector 36. The spectral image may be composed of data for a spatial coordinate x (SPATIAL x) and a spatial coordinate y (SPATIAL y). A PCA angle set may be selected for each wavelength, and spectral images corresponding to the wavelength and the PCA angle set may be obtained respectively. For example, n spectral images may be obtained for n wavelengths (λ1, λ2, λ3, . . . , λn).

As illustrated in FIG. 3, a PCAR spectral matrix 60 may be formed from the spectral images obtained by the light detector 36. The PCAR spectral matrix 60 may represent a virtual spectral data structure obtained through a pixel resampling process of a spatial area and a spectral area. The PCAR spectral matrix 60 may be referred to as a spectral cube. The PCAR spectral matrix 60 may be composed of spatial coordinates (Spatial Axes), that is, SPATIAL X and SPATIAL Y, and may be composed of a plurality of spectral images according to a wavelength λ in a width direction. That is, the PCAR spectral matrix 60 may be composed of data in the form of a spectral cube having spatial coordinates X and Y of the pixel array of the measurement sample, and a wavelength λ as coordinate axes.

The PCAR spectral matrix 60 may be named I(x, y, λ) as coordinates. The spectral image 20 may be referred to as a spectral domain. The PCAR spectral matrix 60 may include the spectral images with spatial coordinates of each pixel P captured by a Field Of View (FOV) of a light sensor included in the light detector 36, and a spectrum of each pixel P according to a wavelength. That is, the PCAR spectral matrix 60 may include a plurality of spectral images and a spectrum representing a change in the light intensity according to wavelengths in each pixel P of the spectral images.

As illustrated in FIG. 4, as indicated by arrows from the spectral images, a light intensity spectrum 70 for wavelengths may be obtained from a pixel P at the same position. The spectrum 70 may represents a change in intensity according to the wavelength of the reflected light Lr at a specific position (pixel).

Hereinafter, the imaging mirror optical system 34 will be explained in detail.

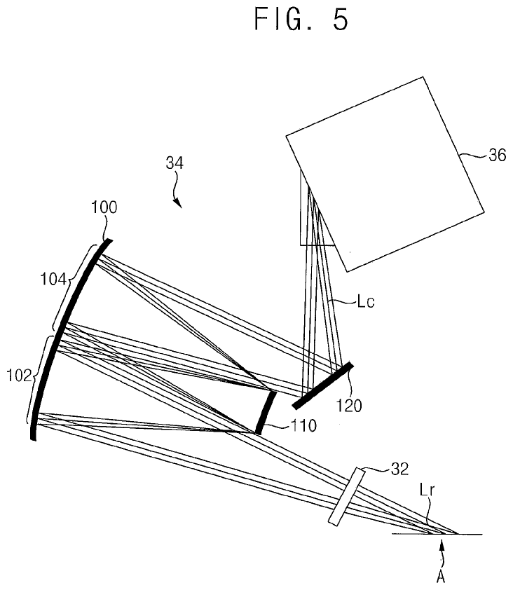

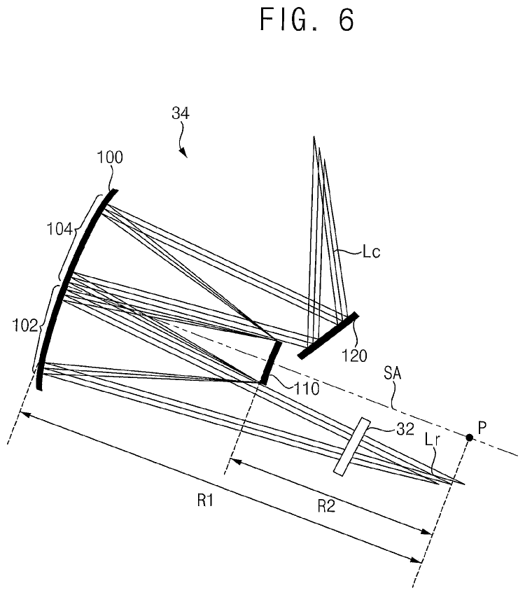

FIG. 5 is a block diagram illustrating an imaging assembly of a spectral imaging ellipsometer in accordance with example embodiments. FIG. 6 is a view illustrating an imaging mirror optical system 34 of the imaging assembly in FIG. 5. FIG. 5 is a block diagram illustrating a light detector 36 of the spectral imaging ellipsometer 10 in FIG. 1.

Referring to FIGS. 5 and 6, an imaging assembly 31 of a spectral imaging ellipsometer 10 may receive reflected light Lr reflected from a sample surface A to detect a two-dimensional image of the sample surface A according to a polarization state. The imaging assembly 31 may include an analyzer 32 as a spectrometer configured to polarize the reflected light Lr, an imaging mirror optical system 34 disposed on an optical path of the reflected light Lr passing through the analyzer 32 and a light detector 36 configured to receive the light passing through the imaging mirror optical system 34 to collect spectral data.

In example embodiments, the imaging mirror optical system 34 may image the reflected light Lr passing through the analyzer 32 on a light receiving surface of the light detector 36. The imaging mirror optical system 34 may have an object plane and an imaging plane as conjugate planes. The object plane of the imaging mirror optical system 34 may be positioned on the wafer surface A, and the imaging plane of the imaging mirror optical system 34 may be positioned on the light receiving plane of the light detector 36.

As illustrated in FIGS. 5 and 6, the imaging mirror optical system 34 may include a first mirror 100 having a concave surface and a second mirror 110 having a convex surface. The first mirror 100 may be a concave spherical mirror, and the second mirror 110 may be a convex spherical mirror. The first mirror 100 and the second mirror 110 may be arranged to produce at least three reflections within the optics. The first mirror 100 and the second mirror 110 form concentric circles. The centers of the radii of curvature R1 and R2 of the first mirror 100 and the second mirror 110 may coincide with one point P. For example, the centers of the radii of curvature R1 and R2 of the first mirror 100 and the second mirror 110 are located at the same point P. The radius R1 of the first mirror 100 may be twice the radius R2 of the second mirror 110. A magnification of the imaging mirror optical system 34 including the first and second mirrors 100 and 110 may be one.

The object plane may be positioned at a first conjugation point, and the imaging plane may be positioned at a second conjugation point. That is, the reflected light Lr from the first conjugate point may be incident and primarily reflected to the first mirror 100 of the imaging mirror optical system 34, and the primarily reflected light may be may be secondary reflected by the second mirror 110 and proceed toward the first mirror again, and then, may be thirdly reflected by the first mirror 100 and travel toward the second conjugate position. A reference axis SA of the optical system may be orthogonal to a plane passing through the point P, the first conjugation point and the second conjugation point.

The reflected light Lr reflected from the wafer surface A may pass through the analyzer 32, and the reflected light Lr that has passed through the analyzer 32 may impinge on a first portion 102 of the first mirror 100. The reflected light Lr passing through the analyzer 32 may be incident off-axis on the first portion 102 of the first mirror 100. The first portion 102 of the first mirror 100 may firstly reflect the reflected light to be directed toward the second mirror 110. The second mirror 110 may secondary reflect the reflected light to be directed toward a second portion 104 of the first mirror 100. The second portion 104 of the first mirror 100 may thirdly reflect the reflected light, and the thirdly reflected light Lc from the second portion 104 of the first mirror 100 may be focused on the light receiving surface of the light detector 36. The light Lc thirdly reflected from the second portion 104 of the first mirror 100 may be emitted off-axis. The first and second portions 102 and 104 may partially overlap.

In example embodiments, the imaging mirror optical system 34 may further include a third mirror 120. The third mirror 120 may be a plane mirror. The third mirror 120 may deflect the light Lc reflected from the second portion 104 of the first mirror 100 toward the light detector 36. The third mirror 120 may redirect the light Lc reflected from the second portion 104 of the first mirror 100 in order to change a position of the light detector 36.

As described above, the imaging mirror optical system 34 may be the mirror-based imaging optical system including at least two mirrors 100 and 110. Since it is composed of reflective mirrors, it may be possible to improve the transmittance of the optical system to improve measurement sensitivity in a narrow wavelength band (i.e., a specific spectrum range) and a measurement speed in a broad wavelength band, and to minimize the focus deviation for each wavelength by reducing the occurrence of chromatic aberration.

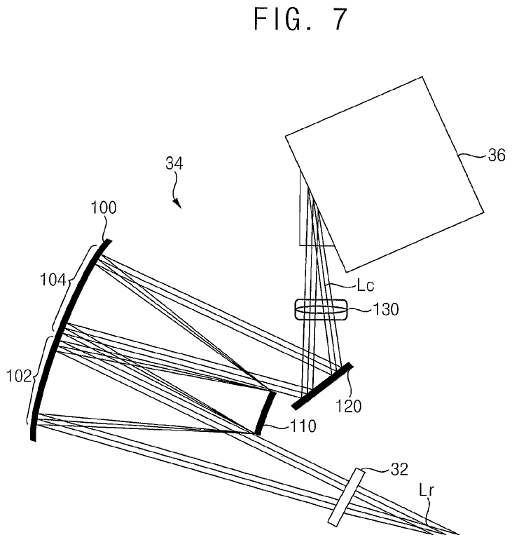

FIG. 7 is a block diagram illustrating an imaging assembly of a spectral imaging ellipsometer in accordance with example embodiments. The imaging assembly may be substantially the same as or similar to the imaging assembly described with reference to FIG. 5 except for an additional compensation lens. Thus, the same reference numerals will be used to refer to the same or like elements and any further repetitive explanation concerning the above elements will be omitted.

Referring to FIG. 7, an imaging assembly of a spectral imaging ellipsometer may include an analyzer 32 as a spectrometer configured to polarize reflected light Lr reflected from a sample surface A, an imaging mirror optical system 34 disposed on an optical path of the reflected light Lr passing through the analyzer 32 and a light detector 36 configured to receive the light passing through the imaging mirror optical system 34 to collect spectral data. The imaging mirror optical system 34 may include a first mirror 100 having a concave surface, a second mirror 110 having a convex surface, a third mirror 120 and a compensation lens 130.

In example embodiments, the imaging mirror optical system 34 may further include the compensation lens 130 configured to compensate for chromatic aberration. The compensation lens 130 may be disposed on a path of the light Lc thirdly reflected from the first mirror 100.

When the analyzer 32 includes a glass substrate or a crystal-type polarizer, chromatic aberration may occur in the reflected light passing through the analyzer 32. The compensation lens 130 may compensate for the chromatic aberration generated by the analyzer 32.

Since the analyzer 32 includes a very thin substrate, the number of lenses of the compensation lens 130 for compensating for chromatic aberration may be very small. Accordingly, the decrease in transmittance by the compensation lens may be insignificant.

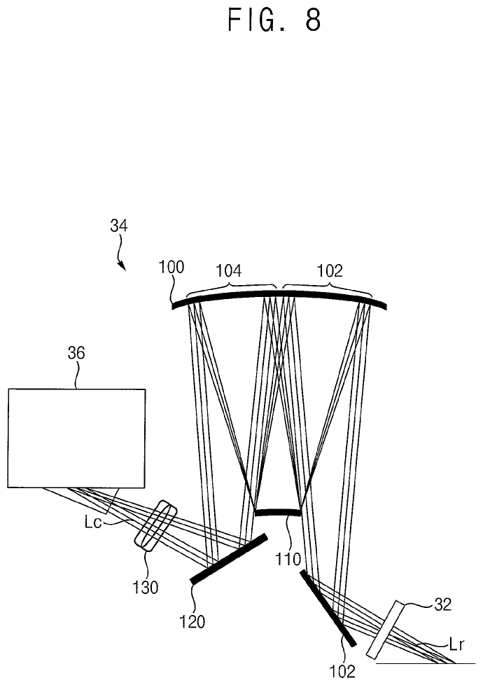

FIG. 8 is a block diagram illustrating an imaging assembly of a spectral imaging ellipsometer in accordance with example embodiments. The imaging assembly may be substantially the same as or similar to the imaging assembly described with reference to FIG. 5 except for an additional plane mirror. Thus, the same reference numerals will be used to refer to the same or like elements and any further repetitive explanation concerning the above elements will be omitted.

Referring to FIG. 8, an imaging mirror optical system 34 of an imaging assembly of a spectral image ellipsometer may include a first mirror 100 having a concave surface, a second mirror 110 having a convex surface, a third mirror 120, a fourth mirror 102 and a compensation lens 130.

In example embodiments, the imaging mirror optical system 34 may further include the fourth mirror 102 configured to redirect reflected light Lr passing through an analyzer 32. The fourth mirror 102 may be a plane mirror. The fourth mirror 102 may be configured to deflect the reflected light Lr passing through the analyzer 32 toward the first mirror 100 in order to change positions of the first to third mirrors 100, 110 and 120.

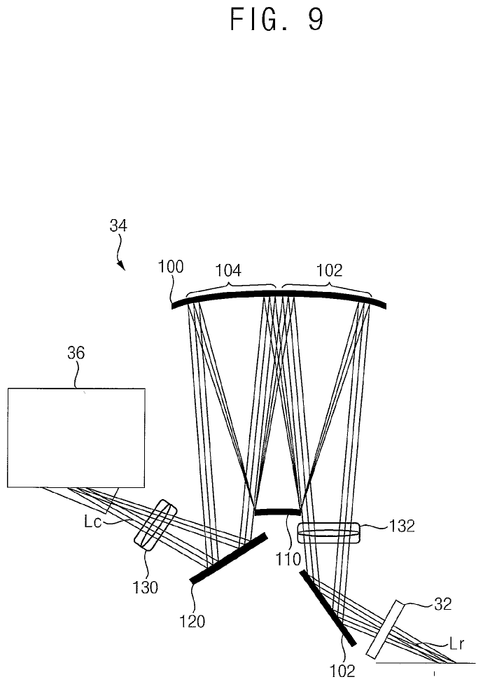

FIG. 9 is a block diagram illustrating an imaging assembly of a spectral imaging ellipsometer in accordance with example embodiments. The imaging assembly may be substantially the same as or similar to the imaging assembly described with reference to FIG. 8 except for an additional compensation lens. Thus, the same reference numerals will be used to refer to the same or like elements and any further repetitive explanation concerning the above elements will be omitted.

Referring to FIG. 9, an imaging mirror optical system 34 of an imaging assembly of a spectral imaging ellipsometer may include a first mirror 100 having a concave surface, a second mirror 110 having a convex surface, a third mirror 120, a fourth mirror 102, a first compensation lens 130 and a second compensation lens 132.

In example embodiments, the imaging mirror optical system 34 of the imaging assembly of the spectral imaging ellipsometer may further include the second compensation lens 132 configured to compensate for chromatic aberration. The second compensation lens 132 may be disposed on a path of reflected light Lr reflected from the fourth mirror 102. The second compensating lens 132 may compensate for the chromatic aberration caused by the analyzer 32.

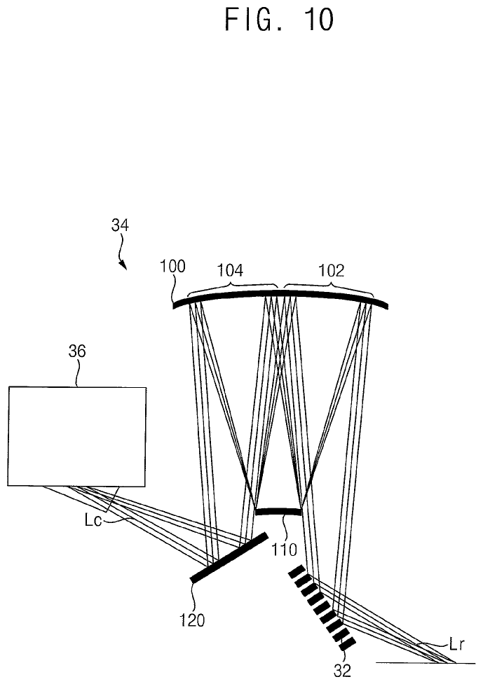

FIG. 10 is a block diagram illustrating an imaging assembly of a spectral imaging ellipsometer in accordance with example embodiments. The imaging assembly may be substantially the same as or similar to the imaging assembly described with reference to FIG. 8 except for a configuration of an analyzer. Thus, the same reference numerals will be used to refer to the same or like elements and any further repetitive explanation concerning the above elements will be omitted.

Referring to FIG. 10, an imaging assembly of a spectral imaging ellipsometer may include an analyzer 32 as a spectrometer configured to polarize reflected light Lr reflected from a sample surface A, an imaging mirror optical system 34 disposed on an optical path of the reflected light Lr passing through the analyzer 32 and a light detector 36 configured to receive the light passing through the imaging mirror optical system 34 to collect spectral data. The imaging mirror optical system 34 may include a first mirror 100 having a concave surface, a second mirror 110 having a convex surface and a third mirror 120.

In example embodiments, the analyzer 32 may be a reflective polarizer. The analyzer 32 may have high reflectivity for broadband wavelengths. Since the analyzer 32 is a reflection type polarizer (i.e., a reflective polarizer), chromatic aberration may not occur. Accordingly, since all optical elements are constituted by mirrors, it may possible to constitute an imaging optical system having no chromatic aberration.

The above spectral imaging ellipsometer may be used to manufacture a semiconductor package including semiconductor devices such as logic devices or memory devices. The semiconductor package may include logic devices such as central processing units (CPUs), main processing units (MPUs), or application processors (APs), or the like, and volatile memory devices such as DRAM devices, HBM devices, or non-volatile memory devices such as flash memory devices, PRAM devices, MRAM devices, ReRAM devices, or the like.

The foregoing is illustrative of example embodiments and is not to be construed as limiting thereof. Although a few example embodiments have been described, those skilled in the art will readily appreciate that modifications are possible in example embodiments without materially departing from the novel teachings and advantages of the present invention. Accordingly, all such modifications are intended to be included within the scope of example embodiments as defined in the claims.

1-10. (canceled)

11. A spectral imaging ellipsometer, comprising:
a light irradiator configured to irradiate a polarized light whose direction changes on a sample surface to generate reflected light;
an analyzer configured to polarize the reflected light reflected from the sample surface;
an imaging mirror optical system disposed on an optical path of the reflected light passing through the analyzer and including a first mirror having a concave surface and a second mirror having a convex surface;
a light detector configured to receive light passing through the imaging mirror optical system to collect spectral data; and
a controller configured to control operations of the light irradiator and the analyzer,
wherein the centers of the radii of curvature of the first mirror and the second mirror are arranged to coincide with one point, and at least three reflections of the reflected light are provided in the first and second mirrors.

12. The spectral imaging ellipsometer of claim 11, wherein the first mirror includes a concave spherical mirror, and the second mirror includes a convex spherical mirror.

13. The spectral imaging ellipsometer of claim 12, wherein the radius of curvature of the first mirror is twice the radius of curvature of the second mirror.

14. The spectral imaging ellipsometer of claim 11, wherein the reflected light passing through the analyzer is incident off-axis on a first portion of the first mirror, and the thirdly reflected light from the first mirror is emitted off-axis from a second portion of the first mirror.

15. The spectral imaging ellipsometer of claim 11, further comprising:
at least one compensation lens configured to compensate for chromatic aberration due to the analyzer.

16. The spectral imaging ellipsometer of claim 11, further comprising:
at least one plane mirror configured to change the path of the reflected light.

17. The spectral imaging ellipsometer of claim 11, wherein the analyzer includes a reflection type polarizer.

18. The spectral imaging ellipsometer of claim 11, wherein the light irradiator includes
a light source configured to generate broadband light;
a monochromator configured to extract light of a specific wavelength from the broadband light;
a polarizer configured to adjusting the polarization direction of the light; and
a compensator configured to adjust a phase difference of the light.

19. The spectral imaging ellipsometer of claim 11, wherein the light detector includes a two-dimensional image sensor.

20. The spectral imaging ellipsometer of claim 11, further comprising:
a processor configured to process the spectral data.

21. A spectral imaging ellipsometer, comprising:
a light irradiator configured to irradiate a polarized light whose direction changes on a sample surface to generate reflected light;
an analyzer configured to polarize the reflected light reflected from the sample surface;
an imaging mirror optical system disposed on an optical path of the reflected light passing through the analyzer and including a first mirror having a concave surface and a second mirror having a convex surface; and
a light detector configured to receive light passing through the imaging mirror optical system to collect spectral data,
wherein the reflected light is firstly reflected by the first mirror, the firstly reflected light is secondarily reflected by the second mirror and travels toward the first mirror again, and then thirdly reflected by the first mirror to be imaged on a light receiving surface of the light detector.

22. The spectral imaging ellipsometer of claim 21, wherein the first mirror includes a spherical concave mirror, and the second mirror includes a spherical convex mirror.

23. The spectral imaging ellipsometer of claim 21, wherein the centers of the radii of curvature of the first mirror and the second mirror are arranged to coincide with one point.

24. The spectral imaging ellipsometer of claim 23, wherein the radius of curvature of the first mirror is twice the radius of curvature of the second mirror.

25. The spectral imaging ellipsometer of claim 21, wherein the reflected light passing through the analyzer is incident off-axis on a first portion of the first mirror, and the thirdly reflected light from the first mirror is emitted off-axis from a second portion of the first mirror.

26. The spectral imaging ellipsometer of claim 21, wherein a magnification of the imaging mirror optical system is one.

27. The spectral imaging ellipsometer of claim 21, further comprising:
at least one compensation lens configured to compensate for chromatic aberration due to the analyzer.

28. The spectral imaging ellipsometer of claim 21, further comprising:
at least one plane mirror configured to change the path of the reflected light.

29. The spectral imaging ellipsometer of claim 21, wherein the analyzer includes a reflection type polarizer.

30. The spectral imaging ellipsometer of claim 21, wherein the light detector includes a two-dimensional image sensor.
